(19) United States
(12) Patent Application Publication
(10) Pub. No.: US 2006/0277409 A1
(43) Pub. Date: Dec. 7, 2006

(54) Method and system of securely enforcing a computer policy

(76) Inventor: Paul Anthony Galwas, Cambridgeshire (GB)

Correspondence Address: CHADBOURNE & PARKE LLP, 30 ROCKEFELER PLAZA, NEW YORK, NY, 10112, US

(21) Appl. No.: 10/547,230

(22) PCT Filed: Mar. 1, 2004
(86) PCT No.: PCT/GB04/00848

§ 371 Date: Aug. 24, 2006

(30) Foreign Application Priority Data
Feb. 28, 2003 (GB) 0305663.8

(51) Int. Cl. H04L 9/00; G06F 17/00; H04K 1/00

(52) U.S. Cl. 713/176; 726/1

(57) ABSTRACT

A method and system for securely enforcing a computer policy uses a secure computer resource (102) which includes both data (106) and policy rules (110) to be applied. The resource also includes a control set (108) which specifies the operations that are permitted on the resource, and the criteria under which permission will be given. An external agent (104) wishing to use the resource sends a request to a secure processor (100), which uses an access processor (120) to confirm that the operation is approved. As the operation proceeds, an operation processor (118) checks against a list of conditions (124) and stops when one occurs. If the condition corresponds to a trigger within the policy, control is passed to a policy processor (122) which securely executes a corresponding method, also defined within the policy. The resource is digitally signed by its owner who can therefore be sure that the embedded policy will always be followed when an approved operation is applied to the resource by an approved user.

The present invention relates to the secure enforcement of computer policies, and particularly although not exclusively to methods and systems which enable enforcement by means of delegated trust.

Many secure computer systems, especially but not only in the banking and financial services industries, make use of automated policies controlled by a “policy enforcer” or auditor. For example, where cryptographic keys are in use, the policy might specify that whenever the system attempts to use an out of date key an entry is written to a secure log for later manual checking by the auditor. A difficulty with this approach is that where a problem occurs it needs to be manually tracked back to its ultimate source after the event. If for example it is found that the system has incorrectly used an invalid key, but has not for some reason written an entry into the log, a lengthy investigation may be required, including an after-the-event check that the routine that writes to the log was not disabled or tampered with by an attacker.

More generally, current high-security processes normally use manual audit to measure conformance with policies after the event. This is both expensive and potentially unreliable. Such automated systems as exist need to be performed on specialist secured computers if they are to be considered secure.

It is an object of the invention at least to alleviate these problems of the prior art.

The invention stems from a development of the concepts disclosed in WO-A-0163385, in the name of the present applicant, which describes a method of selectively controlling access to a computer resource by means of a cryptographic key associated with the resource. The present invention is concerned not just with the controlling of access, but the enforced operation of procedures which the auditor confirms in advance are “safe”. In particular, the invention allows a user to define a policy or method which the auditor accepts as being safe; that is then approved and digitally signed by the auditor. The user then allows that approved policy to run in a secure manner. Should an error be noted at a later stage, the auditor now no longer has to check whether the policy is operating correctly or whether it may have been subverted by an attacker, since that check will now have been done automatically by the system, whenever the policy was run. The fact that the policy has run at all confirms to the auditor that it cannot have been tampered with either before being run or during operation.

According to a first aspect of the present invention there is provided a method of securely enforcing a computer policy comprising:
(a) providing a secure computer resource including:
   (i) data
   (ii) a policy to be applied to the resource, the policy including a trigger and an associated computer method;
(b) executing an operation on the data while watching for an occurrence of the trigger; and
(c) when the trigger occurs, securely enforcing execution of the computer method.

According to a second aspect of the invention there is provided a system of securely enforcing a computer policy comprising:
(a) a secure computer resource including:
   (i) data
   (ii) a policy to be applied to the resource, the policy including a trigger and an associated computer method;
(b) an operation processor for executing an operation on the data while watching for an occurrence of the trigger; and
(c) a policy processor for securely enforcing execution of the computer method when the trigger occurs.

This invention allows pre-defined policies to automate the policy audit function while allowing high levels of security, thereby giving cost efficiencies and allowing higher scalability than may be feasible with manual techniques. It further provides general purpose, and therefore flexible automated and secure processes. In addition, it allows clear and flexible demarcation between highly secure parts of a process (i.e. in policies), for less secure programs, which allows for incremental automation of high security parts of current processes.

The invention may be carried into practice in a number of ways and one specific embodiment will now be described, by way of example, with reference to the accompanying drawings, in which:

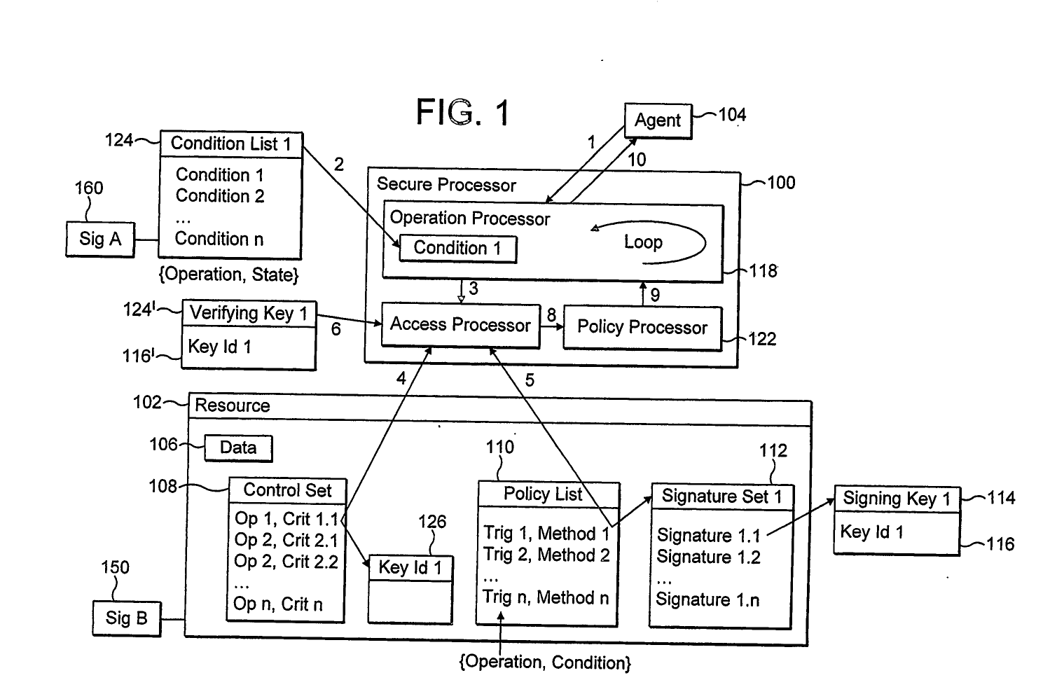

FIG. 1 is a diagrammatic representation of a preferred embodiment of the invention;

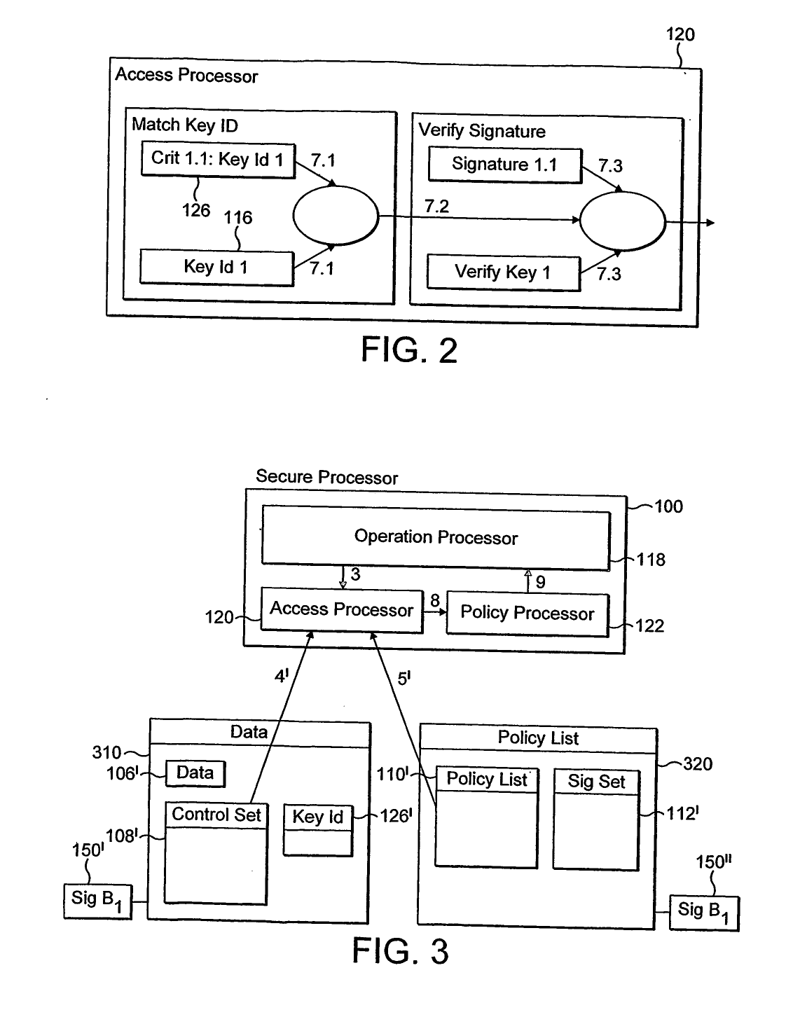

FIG. 2 is a diagrammatic representation of the access processor in FIG. 1; and

FIG. 3 is a diagrammatic representation of the resource in another embodiment

In the preferred embodiment of FIG. 1, the system comprises a secure processor (typically a secure hardware module) 100 that performs an operation on a resource 102 when requested by an external agent 104.

The resource 102 includes data 106, the content of which depends upon the type of resource. If the resource relates to a cryptographic key, for example, the data will include the key value; if the resource relates to database record, the data includes the set of values that correspond to the fields in the record; and if the resource relates to a time stamp, the data defines the time. Also contained within the resource 102 is a control set 108, a policy list 110 and a signature set 112, details of which will now be described.

The control set 108 specifies the set of conditions that the creator or owner of the resource (who will be called for the sake of simplicity the “owner”) has specified that must apply before the secure processor 100 is authorised to perform each operation with the data 106. More specifically, the control set comprises a set of two-part entries, with the first part of each pair defining an operation and the second defining a criterion. The operation identifies an inherent, pre-defined function that the secure processor 100 may do on the data, for example reading, writing, encrypting, signing and so on. The criterion defines what must be true before the secure processor is permitted to perform the corresponding operation.

The policy list 110 specifies a set of activities that the secure processor must automatically invoke as it carries out each operation defined by the control set 108 on the data. The policy list 110 is a list of triggers and corresponding methods (such as a set of instructions in a program) that the secure processor is to perform when the respective trigger is activated. Each trigger identifies a specific condition in a list 124 that will be watched for when the secure processor carries out the operation on the data. Exemplary conditions might include “before starting the operation”, “after completing the operation” and so on. Each condition may be viewed as a pair, namely {Operation, State}. Each trigger corresponds to the pair {Operation, Condition}.

For example, consider a resource which represents an encryption key, with control set entries:
{Op2=encrypt; Crit 2.1=‘before starting’; keyId 2.1=10003}
{Op2=encrypt; Crit 2.2=‘before finishing’; keyId 2.2=10004}

The corresponding operation entry for an operation “encrypt” is:
{encrypt, {before starting); after encrypting a block; after finishing}

The policy list contains: {policy 1; policy 2, . . . }, i.e.
{Trig 1={encrypt, before starting}; method 1}
{Trig 2={encrypt, before finishing}; method 2}

Method 1 checks whether the encrypting key is in service, for example, by checking that its expiry date is in the future. If the key has expired, it ‘makes_new_key’—creates a new key and stores the previous one in some archive. Policy 1 is signed by the owner of signing keyId 1000, who may be responsible for day-to-day key operational management.

Method 2 keeps a total of the amount of data encrypted with the encryption key and ‘makes_new_key’. Policy 2 is signed by keyId 10004, which is owned by the security manager, who sets high level operational policy.

The conditions for the operation encrypt (where the resource represents a cryptographic key) could be the set: {before starting, after encrypting a block, after completing all the encryption}etc, and may include all the relevant states in all possible encryption operations.

A given control set, for a given resource, references only those conditions that are relevant to it. Op 2 might for instance have Criterion 2.1=‘before starting’; and criterion 2.2=‘after completing’, only; and not reference ‘after encrypting a block’, since it is not relevant for that specific resource.

The policy list must contain at least entries that correspond to all the criteria in the corresponding control set.

However, the policy list will often contain a set of policies for all the conditions in all the operations, since typically the policy lists will be unified over many resources and this unification provides an economy of scale in policy management.

Of course, a resource's policy list must contain policy entries at least for all criteria on the corresponding control set.

In many cases the condition list will be embedded in the implementation of the operation processor, so, therefore, will not be distinct or external data. For example, if the resource represents ‘secure time’, the secure processor hardware and firmware will implicitly define the operations {read, modify}, and may explicitly implement the conditions: {before starting, after completing}.

However, where the resource represents more abstract business data, the operation list may be explicit and distinct from the secure processor; the processor may load and perhaps even manipulate it dynamically. For example, if the operation list is associated with a work-flow process, one may want to be able to upgrade the system periodically to load new operations into the secure processor.

Clearly it is not necessary to sign the condition list when it is embedded within the secure processor; but if external, it will be signed.

Associated with each element of the policy list 110 is a signature set 112, comprising a set of one or more digital signatures. Each of these digital signatures is made with a signing key 114 having a key Id 116.

In this embodiment, the signature set is a digital signature with a signing key thus: Sign({trigger, method}, signing key), where ‘a{a, b, . . . }’ means concatenate ‘a’ and ‘b’, etc. although specific implementations may choose to concatenate other data in the signature.

The key ID is cryptographically derived from a {signing, verifying} key-pair, in such a way that the secrecy of [at least] the signing key is not compromised.

For example, the key ID could be:
‘hash({signing key, verifying key})’
where ‘hash( )’ is a one-way digest function with the property that it is very difficult to deduce ‘a’, given ‘hash(a); and ‘{a, b}’ means ‘a’ concatenated with ‘b’.

A criterion references one or more key Ids, thereby associating to a signing key, and corresponding verifying key, without compromising their confidentiality.

The functions of secure processor 100 are performed by an operation processor 118, an access processor 120 and a policy processor 122.

The operation processor 118 executes the steps of the operation that has been requested by the agent 104. As the operation proceeds, the processor watches for the existence of any condition taken from a condition list 124, the contents of this list being dependent upon the operation being performed. The entries in this condition list correspond with the triggers within the policy list 110 of the resource.

When the operation processor reaches a condition within the condition list 124, it stops and passes control to the access processor 120. This checks the resource to ensure that the relevant policies satisfy the associated criteria within the control set 108. If so, control is then passed to the policy processor 122. This is done by means of a verifying key 124 which corresponds to the signing key 114 of the signature set 112 within the resource. The verifying key 124 is identified by means of a key Id 116′ which is the same as the key Id 116 of the signing key 114.

The purpose of verifying key, of course, is to enable the access processor 120 to verify a signature which has purportedly been made with the signing key 114. Accordingly, the secure processor 100 may execute a particular policy during a given operation on a resource if and only if that policy contains a signature within its signature set 112 that was signed by the signing key 114 that the key Id 116′ identifies.

The policy processor executes the appropriate method from the policy list 110, depending upon which condition has triggered, and then returns control back to the operation processor.

By this mechanism, the owner of the signing key 114 (which could be a person or a machine) can:
(a) delegate trust to a signed policy (as represented by the combination of the policy list 110 and the signature set 112);
(b) bind that trust to an individual resource 102, thereby ensuring that a policy is run only against appropriate resources; and
(c) revoke the trust in (b) by ensuring the removal of the verifying Key 124

A signature by the Owner of the signing key can thus be used to convey one or more of these properties:
‘proof of origin’
that the owner of signing key originated the associated policy or policy list;
‘integrity’
that the policy, or policy list, is unchanged from when the owner signed it; and
‘delegation’
that the owner authorises in advance the execution of the method in the associated policy (or methods in the associated policies in the policy list).

In that way, the use to which the data 106 may be put can be predefined and controlled in advance by the owner of the resource or the auditor. Since the policies always stay with the resource throughout its life, no additional external or gatekeeper control is required when the resource is run: the resource effectively polices itself.

The detailed operation of the described system will now be set out, with further reference to FIG. 1 and also to FIG. 2. In order that the operational flow may be easy understood, reference should be made to the paragraph numbers below which correspond with the similarly numbered arrows in the drawings.
1. To start, the secure processor 100 receives an instruction from an external agent 104 to perform Operation 1 on a given resource 102, which it passes to the operation processor 118.
2. The operation processor notes the list 124 of conditions that correspond to Operation 1. It executes Operation 1, step by step, and stops at the first condition in the list, namely Condition 1.
3. The operation processor then passes control to the access processor 120.
4. The access processor requests the control set 108 from the resource, and loads all the operation/criteria pairs that correspond to Operation 1. It also loads all the associated key Ids 126 that each criterion references. In the example shown, the access processor loads criterion 1.1 and key Id 1 both of which are associated with Operation 1.
5. The access processor loads from the policy list 110 all the policies that have a trigger equal to Condition 1, along with the associated signature set 112. In this case, signature set 1 is loaded (these signatures having previously been prepared by means of the signing key 1).
6. The access processor loads all of the verifying keys 124 that are associated with the loaded key Ids. Since signature set 1 is associated with key Id 1, the access processor simply loads the corresponding verifying key 1.
7. Then, for each policy which has been loaded into the access processor, the following steps occur (refer to FIG. 2):
   7.1 the access processor matches key Ids. Specifically, it compares the key Id 126 corresponding Criteria 1.1 with the key Id 116 from the loaded signature set 112.
   7.2 If the match succeeds for at least one key Id, processing continues at step 7.3; otherwise an error is signalled and the procedure ends.
   7.3 Next, the access processor verifies the signature. Specifically, it verifies the signature from the policy that matches key Id 1, namely signature 1.1, with the corresponding verifying key 1.
   7.4 If the verification succeeds, processing continues to step 8; otherwise, an error is signalled and the process stops.
8. Once all of the tests within the access processor have been completed successfully, control passes to the policy processor 122. The policy processor executes the corresponding method in the policy list 110 that has been triggered; in this case, method 1.
9. Once the policy processor has executed the required method, control is returned to the operation processor 118 which continues to step through Operation 1 until Condition 2 is reached. The entire cycle repeats until the operation is complete.
10. Finally, the processor returns control to the agent 104.

Where there is no access to the resource except via the secure processor, there is no need for the resource itself to be further protected. But where direct access is permitted, the response (or at least the data within it) may be cryptographically protected and/or digitally signed, as shown at 150 in FIG. 1. Where the condition lists 124 are separate from the resource, they may also be encrypted and/or signed, as shown at 160 in FIG. 1. The resource and/or the condition list may be signed multiple time—i.e. signature A and signature B may represent signature sets. Where the resource and/or the condition list is or are signed and/or encrypted, the operations processor and the access processor should respectively verify the signature and/or decrypt when reading the data (see the arrows 2 and 4 in FIG. 1). Such an approach allows the owner to protect both integrity and proof of origin, as well as confidentiality (if encryption is used). It will be understood, of course, that the signing key(s) 150, 160 used to sign the condition lists 124 and/or the resource need not be the same as those keys 114 used to make the signatures set 112 that is associated with a policy.

All of the signatures previously mentioned may use either symmetric or asymmetric keys.

In yet another embodiment, shown in FIG. 3, the resource is split between a data portion 310 and a policy portion 320. The former includes data 106, control set 108, and key ids 126, while the latter includes the policy list 110 and the signature set 112. Where the resource may be accessed other than via the secure processor 100, the two separate parts may be digitally signed by signatures or signature sets 150, 150; where confidentiality is important, the two parts may also be encrypted.

The data portion 310 is associated with the policy portion 320 in any convenient way, for example by ensuring that at least one of the signing keys in Sig. B₁ is the same as at least one of the keys in Sig. B₂. When the access processor 120 loads the data and policy portions, as shown by the arrows 4, 5, the system confirms that this is the case.

Where encryption is used, the signature is taken over the encrypted data, i.e.

Sign(Encrypt(Data, Encryption Key, Signing Key)).

As before, the signing keys may be symmetric or asymmetric.

The method and operation of the present invention is applicable to a wide variety of types of resource 102 and associated data 106. However, there are three particular examples which merit special mention, namely cryptography, database records, and time servers. These are addressed separately below.

Where the invention is used in a cryptographic setting, the resource may represent a cryptographic key. The data 106 will then generally contain cryptographic material that determines the particular key, for example the 56-bits of a given Data Encryption Standard (DES) key, or large integers for an RSA public or private key. The data may also contain other information, for example creation date, destruction date, “don't use after” date and so on. Operations that may be defined in respect of the data will include encrypt/decrypt, sign/verify, load, create, delete and so on.

The policy associated with the encrypt or load operations might include a method that checks the “don't use after” date, and signals to an external system if the key is being used inappropriately. The create operation could result in the invocation of a method that populates the data which a new key that is generated with parameters which are defined within the method.

In the database example, the resource may represent a relational database record, with the data containing the values of all of the fields that constitute that record. Operations may typically include read, create (write) modify and delete. Other high-level operations could equally well be envisaged, for example the running of a SQL script.

In the final example, the resource may represent time as supplied by a secure clock. The data then contains the current time, with the operations including such things as read and modify. A resource of this type may be useful in for example a market trading system, in which rules about when things can happen may be encapsulated in the resource policies. Rules could also be set up to control and/or to record the ordering of events in time.

In the specific embodiments so far described, a resource owner or auditor can reliably trust the way in which the resource is going to be used because the rules defining that trust—in other words the policies—are built into the resource itself. It is also anticipated, however, that more complex webs or chains of trust may be created by the use of multiple signatures having multiple owners. For example, a single policy may define multiple rules, each having separately-owned signatures. The resource itself would then decide who will next be allowed to authorise the next step. In this way, work-flows may be built in. An example of this would be a document the entire life cycle of which is to be specified in advance. The policy may define a chain of users who are authorised to review and to modify the document one by one. After the first person has made any required amendments, the policy automatically encrypts the document using the public key of the second person in the list; once the second person has made amendments the document is automatically re-encrypted with the public key of the third person on the list, and so on.

Multiply-owned signatures may also be used to require multiple authorisations. An example of such a situation might be the records of a particular house for sale. Those records may be protected by the house owner and may be stored on the individual databases of a number of different estate agents only if the owner gives permission on an agent-by-agent basis. But if an aggregator service were to wish to take data from a particular agent, for display on an aggregation web site, that data would require authorisation from the agent. The data for an individual house might therefore be defined by an individual house-resource which is protected by two separate signing keys, the first owned by the house owner which authorises the data to be stored on the agent's database, and the second owned by the estate agent which authorises that data to be used by the aggregator.

The system of the present invention may be embodied either in software or in hardware, or in a combination of the two. Typically, the secure processor 100 may be a hardware security module, either with separate individual modules 118, 120, 122 within it, or alternatively corresponding logically separate processes running as a computer program.

In some embodiments, only the secure portions of the operation processor 118 need be contained within a secure processor module: those portions in the operation which are not required to be secure may be outside the secure boundary. In an alternative. embodiment, the operation processor 118, the access processor 120 and the policy processor 122 may comprise separate secure physical modules, or separate logical processes, which communicate with each other via one or more secure channels.

In one arrangement, the policy processor 122 may take the form of a secure module on a motherboard of a client machine (not shown). That enables the individual user to securely execute the required methods without needing to access a central server.

Alternatively, a proxy model may be used, in which a small secure box on a client machine provides sufficient functionality to bootstrap a secure connection with a central policy processor on the server which actually carries out the work.

Where the policy processor is client-based, it could also take the form of a SIM card on a mobile telephone, or a card which fits into an expansion slot within a desktop or laptop computer.

1. A method of securely enforcing a computer policy comprising:
(a) providing a secure computer resource including:
(iii) data
(iv) a policy to be applied to the resource, the policy including a trigger and an associated computer method;
(b) executing an operation on the data while watching for an occurrence of the trigger; and
(c) when the trigger occurs, securely enforcing execution of the computer method.

2. A method as claimed in claim 1 in which the resource further includes a control set specifying:
(a) operations that a user may wish to perform on the resource; and
(b) corresponding criteria defining the circumstances under which each respective operation is permitted.

3. A method as claimed in claim 1 in which the policy includes a signature, an operation being permitted to run only if both its respective criterion is satisfied and the signature is approved.

4. A method as claimed in claim 3 in which the signature is approved if a key Id indicative of a signing key used to create the signature matches a key Id of a verifying key associated with the signing key.

5. A method as claimed in claim 1 in which the policy includes a signature bound to the said trigger and computer method, the trigger and computer method being verified against the signature before the computer method runs.

6. A method as claimed in claim 1 in which the trigger is associated with a condition representative of a program state or an event associated with a program state.

7. A method as claimed in claim 1 in which the operation is executed while watching for an occurrence of one or more conditions within an operation condition set and, when a said condition occurs, verifying the policy before executing the computer method.

8. A method as claimed in claim 7 in which the verification is carried out by a secure access processor which passes control, if the policy is verified, to a secure policy processor to execute the computer method.

9. A method as claimed in claim 2 including controlling a user's access to the data in dependence upon the control set.

10. A method as claimed in claim 1 in which the operation on the data is carried out securely.

11. A method as claimed in claim 1 in which a first part of the operation on the data is executed securely, with a second part being executed non-securely.

12. A method as claimed in claim 1 in which the policy includes a plurality of triggers and associated computer methods.

13. A method as claimed in claim 1 in which the resource includes a plurality of policies.

14. A method as claimed in claim 13 in which the resource includes a plurality of signature sets corresponding to the said plurality of policies.

15. A method as claimed in claim 3 wherein a plurality of signatures associated with a single criteria, an operation being permitted to run only if all of the associated signatures are approved.

16. A method as claimed in claim 2 in which the control set includes a plurality of operations and corresponding criteria, each operation/criteria pair being bound to one or more of a plurality of signatures within the policy, whereby control of the resource is shared between respective signature owners.

17. A system of securely enforcing a computer policy comprising:
(a) a secure computer resource including:
(iii) data
(iv) a policy to be applied to the resource, the policy including a trigger and an associated computer method;
(b) an operation processor for executing an operation on the data while watching for an occurrence of the trigger; and
(c) a policy processor for securely enforcing execution of the computer method when the trigger occurs.

18. A system as claimed in claim 17 in which the operation processor and the policy processor are contained within a secure hardware module.

19. A system as claimed in claim 17 in which the operation processor comprises a secure portion and an insecure portion.

20. A system as claimed in claim 17 including a secure access processor which controls access to the policy processor from the operation processor.

21. A system as in claim 17, wherein the operation processor and the policy processor are contained within a secure hardware module; and a secure access processor, which controls access to the policy processor from the operation processor is contained within the secure hardware module.

22. A system as claimed in claim 17 in which the operation processor and the policy processor are contained with respective hardware modules, and communicate with each other via a secure channel.

23. A system as claimed in claim 22 including a secure access processor which controls access to the policy processor from the operation processor.

24. A system as claimed in claim 23 in which the access processor is contained within a secure hardware module which communicates with the operation processor and the policy processor via secure channels.

25. A method as claimed in claim 1 which the resource is secured by encrypting it.

26. A method as claimed in claim 6 in which the condition is stored within the policy.

27. A method as claimed in claim 6 in which the condition is stored separately from the policy.

28. A method as claimed in claim 27 in which the condition is encrypted.

29. A method as claimed in claim 1 in which the resource is digitally signed.

30. A method as claimed in claim 1, in which the condition is digitally signed.

31. A method as claimed in claim 1, in which the resource is split into a first portion including the data and a second portion including the policy, the first and second portions being digitally signed by a common signature.

32. A system as claimed in claim 17 in which the response is signed by a digital signature, and in which the operation processor or policy processor verifies the signature prior to the said operation being carried out on the data.

33. A system as claimed in claim 17 in which the response is encrypted, and in which the operation processor or policy processor decrypts the response prior to the said operation being carried out on the data.
